(19) United States
(12) Patent Application Publication
(10) Pub. No.: US 2010/0196742 A1
(43) Pub. Date: Aug. 5, 2010

(54) Electricity Generation Using Phototrophic Microbial Fuel Cells

(75) Inventors: Kenneth H. Nealson, Los Angeles, CA (US); Zhen He, Bayside, WI (US)

Correspondence Address: FISH & RICHARDSON, PC, P.O. BOX 1022, MINNEAPOLIS, MN, 55440-1022, US

(73) Assignee: UNIVERSITY OF SOUTHERN CALIFORNIA, Los Angeles, CA (US)

(21) Appl. No.: 12/695,905

(22) Filed: Jan. 28, 2010

Related U.S. Application Data
(60) Provisional application No. 61/148,718, filed on Jan. 30, 2009.

(51) Int. Cl. H01M 8/16

(52) U.S. Cl. 429/2

(57) ABSTRACT

A sediment-type self-sustained phototrophic microbial fuel cell for generating electricity through the syntrophic interaction between photosynthetic microorganisms and heterotrophic bacteria in algae cultivation ponds used for biodiesel production. The microbial fuel cell is operable to continuously produce electricity without the external input of exogenous organics or nutrients.

### CROSS-REFERENCE TO RELATED APPLICATIONS

This application claims the benefit under 35 U.S.C. §119(e)(1) of U.S. Provisional Patent Application Ser. No. 61/148,718, filed Jan. 30, 2009, which is incorporated by reference herein in its entirety.

### TECHNICAL FIELD

This invention relates to microbial fuel cells and the production of energy from algae cultivation ponds used for biodiesel production.

### BACKGROUND

Sunlight is a free energy source and infinite to human beings. In our electricity-based society, generating electricity from sunlight is a sustainable approach to relieve energy stress. Biodiesel production from algae is an indirect way to convert solar energy into chemical energy. (See Hu, Q.; Zhang, C.; Sommerfeld, M. Biodiesel from algae: Lessons learned over the past 60 years and future perspectives. J. Phycol. 2006, 42, 12-12). During algal growth, organic compounds are released via photosynthesis. In addition, the dead algal cells are also accumulated in the pond. The water containing rich organic matter and dead algal cells require the addition capital input to clean up.

Microbial fuel cells (MFCs) are devices that convert chemical energy into electrical energy by the activities of microorganism. (See Logan, B. E.; Hamelers, B.; Rozendal, R. A.; Schroder, U.; Keller, J.; Freguia, S.; Aelterman, P.; Verstraete, W.; Rabaey, K. Microbial fuel cells: methodology and technology. Environ. Sci. Technol. 2006, 40, 5181-5192.) In the anode of a MFC, microorganisms oxidize organic or inorganic matter and generate electrons and protons. Electrons are transported from the anode electrode to the cathode electrode via an external circuit. Protons or other cations diffuse into the cathode compartment through a cation exchange membrane. Oxygen is reduced to form water in the cathode by accepting electrons and protons.

### SUMMARY

In one aspect, a microbial fuel cell includes an anode and a cathode electrically coupled to the anode. The anode and the cathode are configured to be positioned in an algae cultivation pond used for biodiesel production. The algae cultivation pond includes water, organic matter, phototrophic microorganisms, heterotropic bacteria, and sediment. The microbial fuel cell is cell is self-sustaining and operable to convert solar energy into chemical energy.

In another aspect, producing electricity includes positioning an anode and a cathode of a self-sustaining microbial fuel cell in a reservoir, and exposing the microbial fuel cell to solar energy. The reservoir is an algae cultivation pond for biodiesel production, and includes water, sediment, phototrophic microorganisms, and heterotrophic bacteria. The anode is positioned in the sediment.

In another aspect, remediating a body of water includes positioning an anode and a cathode of a self-sustaining microbial fuel cell in a body of water, exposing the microbial fuel cell to solar energy, and converting some of the solar energy into electricity. The body of water is an algae cultivation pond used for biodiesel production, and includes sediment, organic matter, phototrophic microorganisms, and heterotropic bacteria. The anode is positioned in the sediment.

In some implementations, the microbial fuel cell is operable to convert solar energy into chemical energy, and to convert chemical energy into electricity. Electricity is produced in the absence of an external source of carbon. At least some of the electricity is produced via the oxidation of dead algal cells or organic compounds produced during algal photosynthesis. In some implementations, current production by the microbial fuel cell continuously decreases in the presence of the solar energy and continuously increases in the absence of the solar energy.

In some implementations, the sediment is in contact with the anode. The cathode may be suspended above the anode.

In some implementations, water from the reservoir or body of water is provided to a closed reactor. The closed reactor may produce electricity. The closed reactor may be an additional microbial fuel cell, including a single-chamber microbial fuel cell and/or a two-chamber microbial fuel cell.

Although methods and materials similar or equivalent to those described herein can be used in the practice or testing of the present embodiments, suitable methods and materials are described below. All publications, patent applications, patents, and other references mentioned herein are incorporated by reference in their entirety. In case of conflict, the present specification, including definitions, will control. The materials, methods, and examples are illustrative only and not intended to be limiting. It should be appreciated by those skilled in the art that the conception and the specific embodiments disclosed may be readily utilized as a basis for modifying or designing other structures for carrying out the same purposes as described herein. It should also be realized by those skilled in the art that such equivalent constructions do not depart from the spirit and scope as set forth in the appended claims.

### DESCRIPTION OF DRAWINGS

FIG. 1 is an illustration of an energy-producing process combining microbial fuel cell technology and algae biodiesel production.

FIG. 2 is an illustration of sediment phototrophic microbial fuel cell.

FIGS. 3A and 3B show electric current production under the full-spectrum light after one month and five months, respectively.

### DETAILED DESCRIPTION

The energy output from algal cultivation may be increased by converting the “wastes”—organic matter and dead algal cells—into useful energy. Converting the organic matter and dead algal cells into useful energy (e.g., electrical energy) may facilitate a reduction in cost of biodiesel fuel made from algae. See Attachment 1 (He et al., “Self-sustained Phototrophic Microbial Fuel Cells Based on the Syntropic Cooperation between Photosynthetic Microorganisms and Heterotrophic Bacteria). The conversion of organic matter and dead algal cells into useful energy may be realized by using microbial fuel cell (MFC) technology. The MFCs described herein have various configurations, depending on where they will be applied and what substrates are used for electricity production. Two-chamber or single-chamber MFCs are closed reactors that may be used for treating wastewater or water containing targeted compounds. Sediment MFCs are open systems that may be applied in natural water to harvest electric energy from the oxidation of organic compounds in sediments. Phototrophic MFCs use light (e.g., sunlight) to drive the production of chemicals that may be used for electricity production. This process involves phototrophic microorganisms that can convert solar energy into chemical energy. The chemical energy may be converted into electric energy later by microorganisms or metal catalysts.

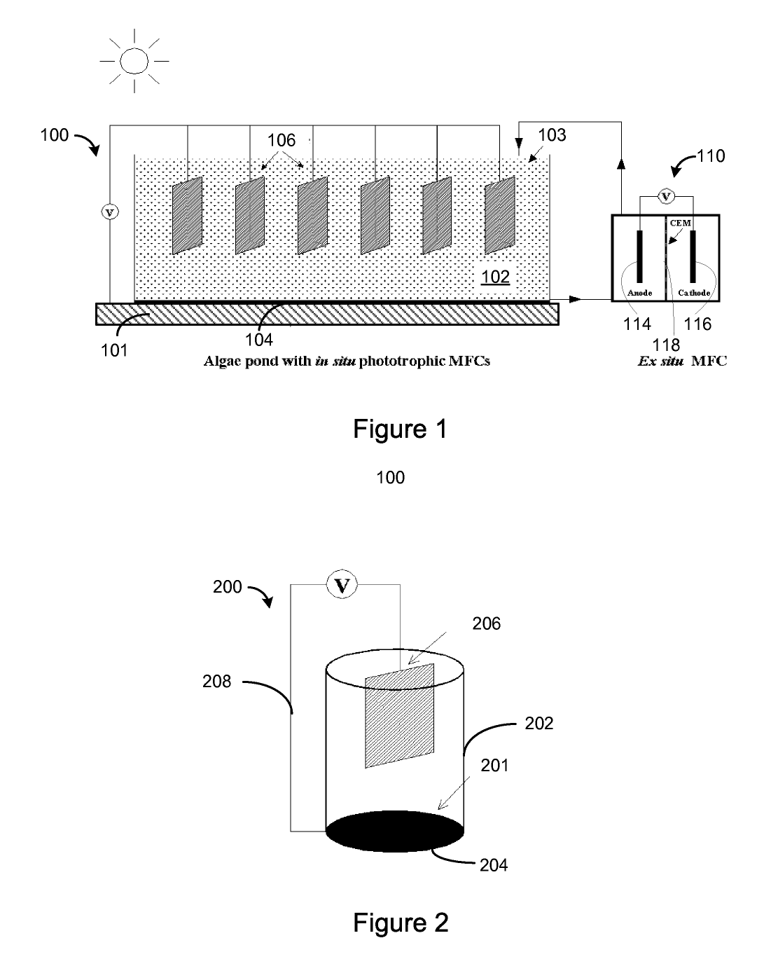

FIG. 1 illustrates in situ and ex situ MFCs. The in situ and ex situ MFCs may be used together or separately. The in situ MFC 100 is a sediment-type phototrophic MFC that may be installed in an algal pond 102 or other reservoir (e.g., a bioreactor) with sediment 101 including algal cells 103. The anode electrodes 104 (graphite felt, plate or other types of carbon/graphite materials) are placed on the bottom of the pond or reservoir 102, while the cathode electrodes 106 (which may include substantially the same materials as the anode electrode) are positioned (e.g., suspended) above the anode electrodes 104. Electricity may be produced via the oxidation of dead algal cells or organic compounds accumulated during algal photosynthesis. The ex situ MFC 110, with anode 114, cathode 116, and cation exchange membrane 118, is a two-chamber or single-chamber MFC used for treating the effluent from the algal pond. The water after treatment may be pumped back to the pond or reservoir to conserve nutrients for algal growth.

The process depicted in FIG. 1 may reduce the cost of treating water containing organic compounds and dead algal cells by removing undesirable waste. As an additional benefit, the in situ and ex situ MFCs may be used to produce electricity. Thus, energy output may be enhanced (e.g., maximized), thereby improving economic feasibility of biodiesel production from algae in algal ponds. In some embodiments, the in situ sediment phototrophic MFC 100 may utilize the oxygen evolved from photosynthesis for its cathode reaction, thereby reducing the need for (and cost of) oxygen supply that is usually required by other MFCs.

### Example

The sediment MFC 200 illustrated in FIG. 2 was built in a 1-L glass beaker 202 that was open to air. The anode electrode 204 made of round graphite felt (project surface area of about 78 cm², Electrolytica Inc., Amherst, N.Y.) was placed on the bottom. The cathode electrode 206 was a piece of graphite plate (POCO Graphite Inc., Decatur, Tex.) that was suspended above the anode electrode. The distance between the top of the anode and the bottom of the cathode electrode was about 12 cm. Copper wire 208 was used to connect the anode and cathode electrodes. Sediment 201 and lake water (Mono Lake, Calif.) mixed with tap water was filled into the glass beaker 202. The sediment layer on the anode electrode was about 0.5 cm thick, and the water volume in the beaker was about 950 mL. A full spectrum light bulb (BlueMax Lighting, Jackson Mich.) was used as a light source for the MFC. The light was controlled by a timer with an on/off period of 8/16 hours.

Electricity was produced from the self-sustained sediment phototrophic MFC, based on syntrophic interaction between photosynthetic microorganisms and heterotrophic bacteria, without the input of an external carbon source. As used herein, a “self-sustained” MFC generally refers to a MFC that operates to produce electricity without the input of an external carbon source. The heterotrophic bacteria oxidized organic compounds, hydrogen, or a combination thereof produced by photosynthetic microorganisms via photosynthesis to generate electricity. Current production by the sediment MFC evolved and exhibited different results with the effects of light during the testing period.

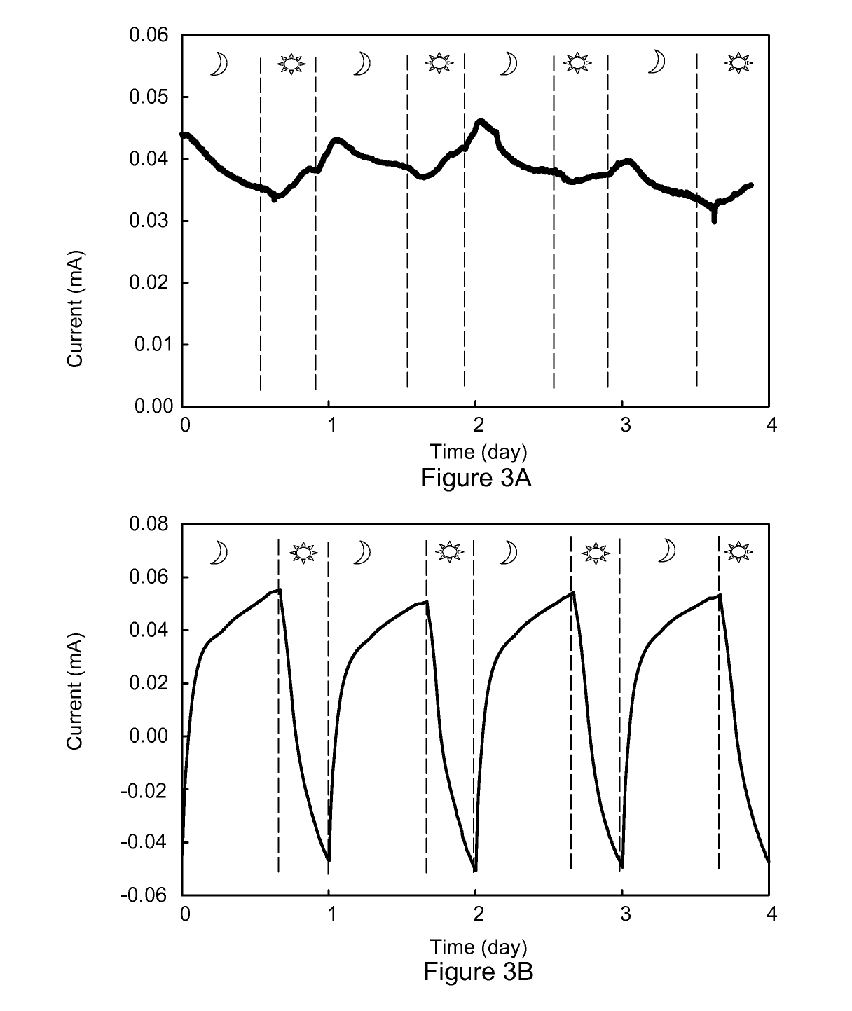

In the first month, current generation increased under the light (indicated by the sun symbol) and decreased in the dark (indicated by the moon symbol), as shown in FIG. 3A. The peak current of 0.041±0.002 mA appeared several hours after the light was switched off. This trend changed slowly over time, the peak current occurring near the end of the dark period. The bottom (or lowest point) of the current curve decreased eventually to a negative value under the light. After five months' operation, current production showed an opposite trend, as shown in FIG. 3B. The turnover of current increase or decrease occurred when the light was switched off or on. Under the light, the current decreased rapidly to −0.045±0.003 mA. The current started to increase in the dark and reached the highest value of 0.054±0.002 mA.

A number of embodiments of the invention have been described. Nevertheless, it will be understood that various modifications may be made without departing from the spirit and scope of the invention. Accordingly, other embodiments are within the scope of the following claims.

What is claimed is:

1. A microbial fuel cell, comprising:
an anode; and
a cathode electrically coupled to the anode,
wherein the anode and the cathode are configured to be positioned in an algae cultivation pond used for biodiesel production, the algae cultivation pond comprising:
water;
organic matter;
phototrophic microorganisms; and
heterotropic bacteria; and
sediment, and
wherein the microbial fuel cell is self-sustaining and operable to convert solar energy into chemical energy.

2. The microbial fuel cell of claim 1, wherein the anode is in contact with the sediment.

3. The microbial fuel cell of claim 1, wherein the cathode is suspended above the anode.

4. The microbial fuel cell of claim 1, wherein the microbial fuel cell is operable to convert at least some of the chemical energy into electrical energy.

5. A method of producing electricity, comprising
positioning an anode and a cathode of a self-sustaining microbial fuel cell in a reservoir, the reservoir comprising water, sediment, phototrophic microorganisms, and heterotrophic bacteria; and
exposing the microbial fuel cell to solar energy,
wherein the anode is positioned in the sediment, and the reservoir is an algae cultivation pond for biodiesel production.

6. The method of claim 5, wherein the microbial fuel cell is operable to convert at least some of the solar energy into chemical energy, and to convert at least some of the chemical energy into electricity.

7. The method of claim 5, further comprising providing water from the reservoir to a closed reactor for producing additional electricity.

8. The method of claim 7, wherein the closed reactor comprises an additional microbial fuel cell.

9. The method of claim 8, wherein the additional fuel cell comprises a single-chamber microbial fuel cell.

10. The method of claim 8, wherein the additional fuel cell comprises a two-chamber microbial fuel cell.

11. The method of claim 5, wherein electricity is produced in the absence of an external source of carbon.

12. The method of claim 5, further comprising assessing current production by the microbial fuel cell, wherein the current production continuously decreases in the presence of the solar energy and continuously increases in the absence of the solar energy.

13. A method of remediating a body of water, the method comprising:
positioning an anode and a cathode of a self-sustaining microbial fuel cell in the body of water, the body of water comprising sediment, organic matter, phototrophic microorganisms, and heterotropic bacteria;
exposing the microbial fuel cell to solar energy; and
converting some of the solar energy into electricity,
wherein the anode is positioned in the sediment, and the body of water is an algae cultivation pond used for biodiesel production.

14. The method of claim 13, wherein converting some of the solar energy into electricity comprises converting some of the solar energy into chemical energy, and converting some of the chemical energy into electricity.

15. The method of claim 13, further comprising providing water from the body of water to a closed reactor for remediation of the water.

16. The method of claim 15, wherein the closed reactor comprises an additional microbial fuel cell.

17. The method of claim 16, wherein the additional microbial fuel cell comprises a single-chamber microbial fuel cell.

18. The method of claim 16, wherein the additional microbial fuel cell comprises a two-chamber microbial fuel cell.

19. The method of claim 13, wherein positioning the anode and the cathode comprises suspending the cathode above the anode.

20. The method of claim 13, wherein at least some of the electricity is produced via the oxidation of dead algal cells or organic compounds produced during algal photo synthesis.
